(19) United States
(12) Patent Application Publication
(10) Pub. No.: US 2022/0001810 A1
(43) Pub. Date: Jan. 6, 2022

(54) ELECTRONIC EQUIPMENT HOLDER

(71) Applicant: TOYODA GOSEI CO., LTD., Kiyosu-shi (JP)

(72) Inventors: Minoru SHIBATA, Kiyosu-shi (JP); Atsushi KOBAYASHI, Kiyosu-shi (JP)

(21) Appl. No.: 17/333,357

(22) Filed: May 28, 2021

(30) Foreign Application Priority Data
Jul. 6, 2020 (JP) 2020-116517

(51) Int. Cl. B60R 11/02; B60N 3/10

(52) U.S. Cl. CPC B60R 11/02; B60R 2011/0075; B60N 3/101

(57) ABSTRACT

An electronic equipment holder includes a first housing part to hold an electronic equipment including a display, and a second housing part that is adjacent to the first housing part and includes a wall part including a partially notched communicating part to communicate with the first housing part. The display can be viewed from a side of the second housing part through the communicating part. The first housing part are integrally formed with the second housing part.

### CROSS-REFERENCES TO RELATED APPLICATIONS

The present patent application claims the priority of Japanese patent application No. 2020/116517 filed on Jul. 6, 2020, the entire contents of which are herein incorporated by reference.

### TECHNICAL FIELD

The present invention relates to an electronic equipment holder.

### BACKGROUND ART

An electronic equipment holder is known which is configured to hold an electronic equipment such as a smartphone by using an attachment to be installed on a cup holder provided in the central cluster of a vehicle (see e.g., JP 2012/214087 A).

The electronic equipment holder is arranged as a slide-type cup holder in the central cluster of the vehicle. The attachment can be inserted into the cup holder. The attachment is composed of an insertion body with a cylindrical shape and a case body formed at an upper part of the insertion body. The case body is formed so as to house the smartphone. The surface of the attachment is notched so as to operate the case body and the housed smartphone. Thus, by putting the smartphone in the attachment to be inserted into the cupholder, the smartphone can be housed in the cup holder.

### SUMMARY OF INVENTION

The electronic equipment holder disclosed in JP 2012/214087 A is configured such that the cupholder can be also used as an electronic equipment housing part to house an electronic equipment such as a smartphone by the attachment inserted into the cup holder. Thus, the arrangement of the cupholder and the electronic equipment housing part is not optimized.

It is an object of the invention to provide an electronic equipment holder that is configured to optimize the arrangement of the electronic equipment housing part and the cupholder.

(1) According to an embodiment of the invention, an electronic equipment holder comprises:
a first housing part to hold an electronic equipment comprising a display; and
a second housing part that is adjacent to the first housing part and comprises a wall part comprising a partially notched communicating part to communicate with the first housing part,
wherein the display can be viewed from a side of the second housing part through the communicating part, and
wherein the first housing part are integrally formed with the second housing part.

The electronic equipment holder according to (1) above may be modified by any one or a combination of (2) to (12) below.

(2) The electronic equipment holder is configured so as to be arranged at a center console of a vehicle such that the display can be more easily viewed from a driver's seat side of the vehicle than a passenger's seat side of the vehicle.

(3) The first housing part comprises a power feeder to feed power to the electronic equipment.

(4) The power feeder is configured to be contact-free.

(5) The first housing part comprises an inclined wall part to allow the electronic equipment to be leaned thereon.

(6) The first housing part comprises a positioning holder to hold the electronic equipment at a predetermined position.

(7) A bottom part of the first housing part and the second housing part comprises a groove part in which a wire can be arranged.

(8) The second housing part is configured to house a cup, and the first housing part and the second housing part are integrally formed as a cup holder provided in a vehicle interior of the vehicle.

(9) The electronic equipment holder comprises two of the second housing part and the communicating part between the two second housing parts.

(10) The cup holder is arranged at an armrest part of seat of the vehicle.

(11) The electronic equipment holder comprises plural ones of the cup holder.

(12) The cup holder is arranged above an instrument panel of the vehicle.

### Advantageous Effects of Invention

According to an embodiment of the invention, an electronic equipment holder can be provided that is configured to optimize the arrangement of the electronic equipment housing part and the cupholder.

### BRIEF DESCRIPTION OF DRAWINGS

FIG. 1 is a perspective view showing a whole structure of an electronic equipment holder according to the first embodiment of the invention.

FIG. 2A is a top view showing the electronic equipment holder according to the first embodiment.

FIG. 2B is a cross sectional view taken along the line A-A in FIG. 2A.

FIG. 3A is a top view showing the electronic equipment holder in which the electronic equipment holder is rotated by 90° from the electronic equipment holder shown in FIG. 2A.

FIG. 3B is a cross sectional view taken along the line B-B in FIG. 3A.

FIG. 4 is a perspective view showing an example of attaching the electronic equipment holder to vehicle, which shows vehicle interior to which the electronic equipment holder is attached to the center console.

FIG. 5A is a top view showing an electronic equipment holder according to the second embodiment.

FIG. 5B is a perspective view showing an example of attaching the electronic equipment holder to vehicle, which shows vehicle interior to which the electronic equipment holder is attached to the center console.

FIG. 6 is a perspective view showing an electronic equipment holder according to the third embodiment.

FIG. 7A is a perspective view showing a whole seat of vehicle in which an electronic equipment holder according to the fourth embodiment is applied.

FIG. 7B is a perspective view showing a state that the electronic equipment holder is arranged at an armrest part (armrest) of the seat of vehicle.

FIG. 8 is a perspective view showing a state that the electronic equipment holder according to the fifth embodiment is arranged at an armrest part (armrest) in the center of rear seat of vehicle.

FIG. 9 is a perspective view showing a state that the electronic equipment holder according to the sixth embodiment is arranged at an instrument panel of vehicle.

### DESCRIPTION OF EMBODIMENTS

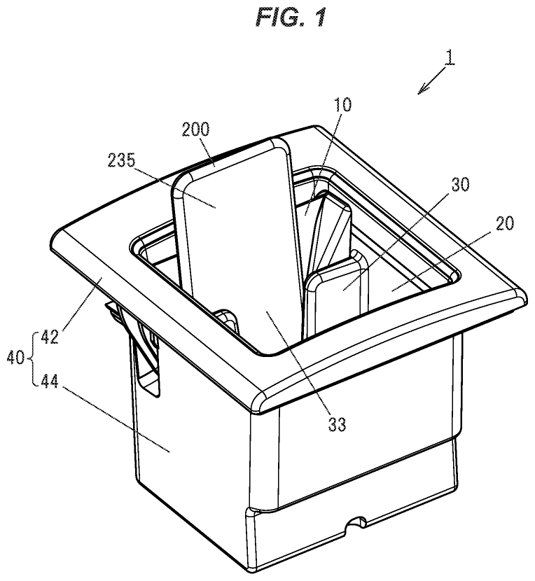

FIG. 1 is a perspective view showing a whole structure of an electronic equipment holder 1 according to the first embodiment of the invention. As shown in FIG. 1, the electronic equipment holder 1 according to the invention comprises an electronic equipment housing part 10 as a first housing part holding an electronic equipment 200 comprising a display 235, and a cup housing part as a second housing part comprising a wall part 30 comprising a communicating part 33 communicating with the first housing part 10 which is partially notched and can house a cup adjacent to the electronic equipment housing part 10. The display 235 can be viewed from a cup housing part 20 side through the communicating part 33. The electronic equipment housing part 10 and the cup housing part 20 are configured so as to be integrated and arranged.

The electronic equipment holder 1 according to the invention can be arranged at vehicle interior of the vehicle 300. The electronic equipment 200 is smartphone, cell phone, or mobile device and so on. In the present embodiment, the electronic equipment 200 is an electronic equipment supposing the smartphone.

The electronic equipment housing part 10 houses the electronic equipment 200 such as smartphone. In the present embodiment, the electronic equipment 200 is housed while leaned on the electronic equipment housing part 10.

In addition, the cup housing part 20 is configured to define a shape that can house a cup or a bottle including drink and so on. The cup housing part 20 can be used for housing other objects such as a pen and glasses.

### First Embodiment

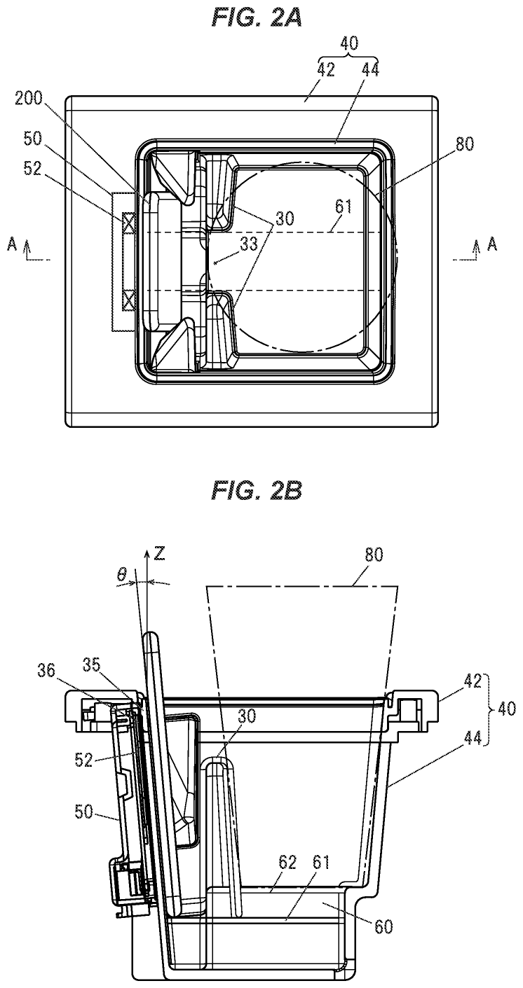

FIG. 2A is a top view showing the electronic equipment holder according to the first embodiment. FIG. 2B is a cross sectional view taken along the line A-A in FIG. 2A.

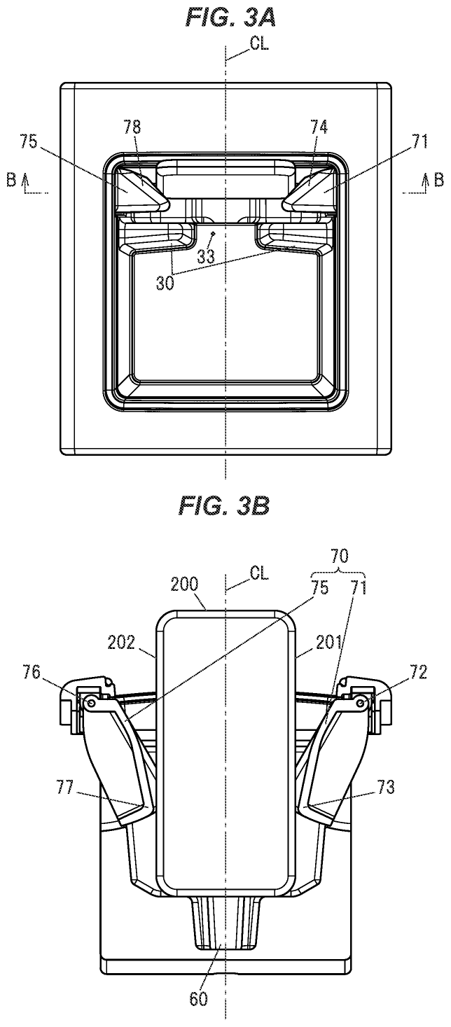

FIG. 3A is a top view showing the electronic equipment holder in which the electronic equipment holder is rotated by 90° from the electronic equipment holder shown in FIG. 2A. FIG. 3B is a cross sectional view taken along the line B-B in FIG. 3A.

As shown in FIGS. 1 to 3B, the electronic equipment holder 1 comprises the electronic equipment housing part 10 as the first housing part and the cup housing part 20 housing a cup 80 etc., as the second housing part in a body 40. In the present embodiment, the body 40 comprises a flange part 42 serves as an attachment flange for a center console 310 of the vehicle 300, and a main body part 44 comprising the electronic equipment housing part 10 and the cup housing part 20 as an interior space. For example, the flange part 42 can be formed of a designed member. For example, the main body part 44 can be made of hard resin.

As shown in FIGS. 1 to 3B, the wall part 30 is formed between the electronic equipment housing part 10 as the first housing part and the cup housing part 20 as the adjacent second housing part. As shown in FIG. 2A, the wall part 30 separates the electronic equipment housing part 10 and the cup housing part 20.

In the meantime, a communicating part 33 communicating the electronic equipment housing part 10 and the cup housing part 20 by notching around the center of the wall part 30. As shown in FIGS. 1 and 2A, the display 235 of the electronic equipment 20 housed in the electronic equipment housing part 10 can be viewed from a cup housing part 20 side through the communicating part 33. Specially, the display 235 of the electronic equipment 200 can be more easily viewed through the communicating part 33 if the cup 80 is not arranged in the cup housing part 20.

Thus, if the electronic equipment housing part 10 housing the electronic equipment 200 such as smartphone and the cup housing part 20 housing the cup 80 are integrated, the electronic equipment holder 1 can be served as a cup holder housing the electronic equipment 200 such as smartphone by forming the communicating part 33 in the above wall part 30. And thus, it is possible to define the most suitable housing structure.

As shown in FIGS. 2A and 2B, the electronic equipment housing part 10 as the first housing part comprises a power feeder to feed power to the electronic equipment 200. Herein, the power feeder also includes a battery charger with a feed circuit.

For example, the power feeder is defined as a contact-free power feeder. As shown in FIG. 2A, a battery charger 50 as the power feeder is attached to an outside wall part 36 of a rear wall part 35 to allow the electronic equipment housing part 10 to be leaned thereon.

A power feed coil 52 of the battery charger 50 is arranged to be opposite to a power receiving coil (not shown) attached inside the electronic equipment 200 that is housed inside the electronic equipment housing part 10 when leaning the electronic equipment 200 on the electronic equipment housing part 10.

As shown in FIGS. 2A and 2B, the power feed coil 52 allows the electronic equipment 200 to be fed and charged by being electromagnetically connected to the power receiving coil (not shown) installed on the electronic equipment 200 being housed in the electronic equipment housing part 10. The battery charger 50 is used such that the electronic equipment 200 can be fed and charged by electromagnetic introduction contact-free to the electronic equipment 200 through the power receiving coil of the electronic equipment 200 when the power feed coil 52 is fed. For example, the battery charger 50 is ready to be used for the feeding and charging when the vehicle 300 is in driving mode or adaptive cruise control (ACC) mode and therefore the electronic equipment 200 can be fed and charged if only the electronic equipment 200 is inserted and put in the electronic equipment holder 1.

The electronic equipment housing part 10 as the first housing part comprises the rear wall part 35 as an inclined wall part that leans and stands the electronic equipment 200. The rear wall part 35 shown in FIG. 2B is formed as an inclined wall part having an inclined angle θ against the vertical direction Z shown in FIG. 2B. For example, the inclined angle θ is angle more than zero in FIG. 2B. The inclined angle θ can be set while considering the inclined angle of the cup having a cone shape. Hereby, space between the electronic equipment housing part 10 and the cup housing part 20 can be optimized and minimized.

The electronic equipment 200 can be held steadily by inclining the electronic equipment 200 and standing the electronic equipment 200 on the rear wall part 35 as the inclined wall part. In addition, the electronic equipment 200 can be held steadily in acceleration in starting, braking in parking, swinging in driving for vehicle when the electronic equipment holder 1 is attached to the vehicle.

A bottom part 60 of the electronic equipment housing part 10 as the first housing part and the cup housing part 20 as the second housing part comprises a groove part 61 that can route wires. As shown in FIG. 2B, the groove part 61 forms a tunnel structure under a bottom plate 62.

For example, a USB cable etc. for the feeding and charging of the electronic equipment 200 with wire is arranged in the groove part 61. Thus, the electronic equipment 200 can be fed and charged by attaching a connector of the USB cable etc. thereto.

The electronic equipment housing part 10 comprises a holder (i.e., a holding mechanism or a center-aligning holding mechanism) 70 to hold the electronic equipment 200 at a predetermined position. As shown in FIGS. 3A and 3B, the holder 70 supports the electronic equipment 200 to sandwich the electronic equipment 200 by two members, a right holding member 71 and a left holding member 75.

The right holding member 71 and the left holding member 75 respectively have an arm shape rotatably supported by rotational fulcrums 72, 76. In the right holding member 71, an abutment 73 abuts on a side surface 201 of the electronic equipment 200 around the rotational fulcrum 72. In addition, as not shown in FIGS, for example, the right holding member 71 comprises spring to enforce energizing force that energizes the abutment 73 to the side surface 201 of the electronic equipment 200. Similarly, in the left holding member 75, the abutment 77 abuts on a side surface 202 of the electronic equipment 200 around the rotational fulcrum 76. In the meantime, the holder is not always limited to the holder 70 if the holder can center-align the electronic equipment by methods such as rotationally support and sliding.

Thereby, the electronic equipment 200 is aligned at the center line CL. The position between the electronic equipment 200 and the power feed coil 52 is steadily determined and therefore the feeding and charging can be stably conducted with a high charging efficiency in the above contact-free feeding and charging.

Further, as shown in FIG. 3A, the right holding member 71 and the left holding member 75 respective comprise the inclined abutments 74, 78. The inclined abutment 74 of the right holding member 71 abuts on the side surface 201 of the electronic equipment 200 and presses the electronic equipment 200 on the rear wall part 35. Similarly, the inclined abutment 78 of the left holding member 75 abuts on the side surface 202 of the electronic equipment 200 and presses the electronic equipment 200 on the rear wall part 35.

Thereby, the electronic equipment 200 is pressed on the rear wall part 35, and the position between the electronic equipment 200 and the power feed coil 52 is steadily determined, and therefore the feeding and charging can be stably conducted with a high charging efficiency in the above contact-free feeding and charging. In addition, the electronic equipment 200 can be held steadily in acceleration in starting, braking in parking, swinging in driving for the vehicle 300 when the electronic equipment holder 1 is attached to the vehicle.

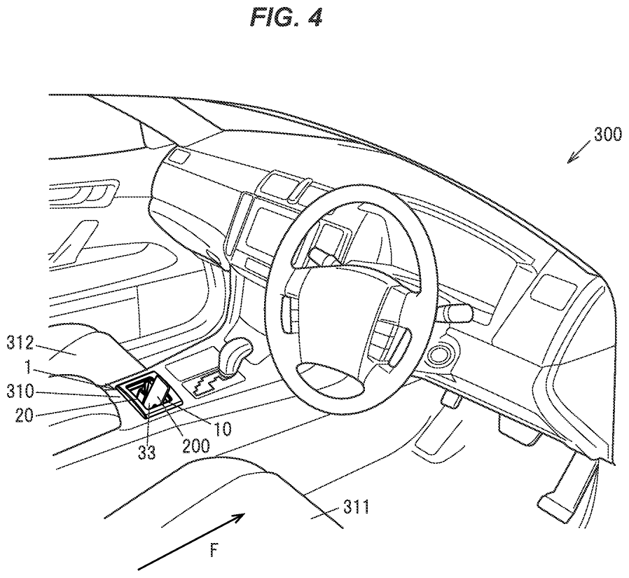

FIG. 4 is a perspective view showing an example of attaching the electronic equipment holder to the vehicle 300, which shows vehicle interior to which the electronic equipment holder is attached to the center console 310. The electronic equipment holder 1 can hold the electronic equipment 200 and serves as a cup holder holding a cup. That is, the cup housing part 20 as the second housing part can house a cup. The electronic equipment housing part 10 as the first housing part and the cup housing part 20 are attached inside the vehicle interior of the vehicle 300 as an integral cup holder.

As shown in FIG. 4, the electronic equipment housing part 10 can house the electronic equipment 200 to lean the electronic equipment 200 in a front direction (F-direction) of the vehicle 300. Thus, the electronic equipment 200 can be held steadily in acceleration in starting, braking in parking, swinging in driving for the vehicle 300.

In addition, when the electronic equipment holder 1 is attached in the center console 310, the electronic equipment 200 can be arranged in the electronic equipment housing part 10 from a driver's seat (D-seat) 311 side or a passenger's seat (P-seat) 312 side. If the cup is not arranged at the cup housing part 20, the display 235 of the electronic equipment 200 can be more easily viewed through the communicating part 33.

### Effects of the First Embodiment

(1) In the first embodiment, the wall part 30 is formed between the electronic equipment housing part 10 as the first housing part and the cup housing part 20 as the adjacent second housing part. The communicating part 33 communicating the electronic equipment housing part 10 and the cup housing part 20 is formed by notching around the center of the wall part 30. Thus, the display 235 of the electronic equipment 200 housed in the electronic equipment housing part 10 can be viewed from the cup housing part 20 side through the communicating part 33.

(2) The electronic equipment housing part 10 as the first housing part comprises the inclined wall part leaning the electronic equipment 200. Thus, the space between the electronic equipment housing part 10 and the cup housing part 20 can be minimized. In addition, the electronic equipment 200 can be steadily held by leaned on the rear wall part 35 as the inclined wall part. Further, the electronic equipment 200 can be held steadily in acceleration in starting, braking in parking, swinging in driving for the vehicle 300 when the electronic equipment holder 1 is attached to the vehicle.

(3) The bottom part 60 of the electronic equipment housing part 10 as the first housing part and the cup housing part 20 as the second housing part comprises the groove part 61 where wires can be arranged. In the groove part 61, for example, USB cable can be arranged in the groove part 61. Thus, the electronic equipment 200 can be supplied or charged with cable by attaching a connector such as USB cable.

(4) The electronic equipment housing part 10 comprises the holder 70 (i.e., the center-aligning holding mechanism) to hold the electronic equipment 200 at the predetermined position. The electronic equipment 200 is center-aligned at the center line CL. Also, the electronic equipment 200 is pushed onto the rear wall part 35. Thus, the feeding and charging can be stably conducted with a high charging efficiency in the above contact-free feeding and charging. Further, the electronic equipment 200 can be held steadily in acceleration in starting, braking in parking, swinging in driving for vehicle 300 when the electronic equipment holder 1 is attached to the vehicle 300.

### Second Embodiment

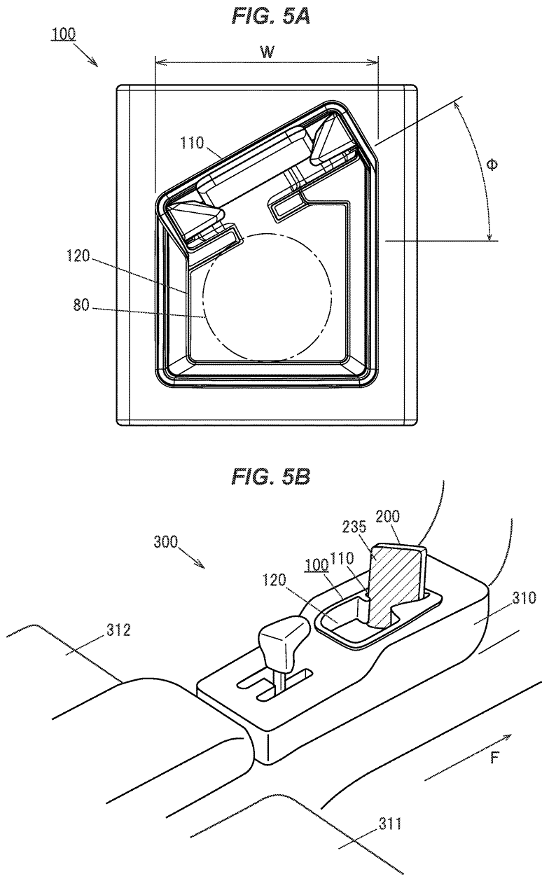

The second embodiment is configured so as to be more easily viewed from the driver's seat 311 side of the vehicle 300 than the passenger's seat 312 side of the vehicle 300 when viewing the display 235 of the electronic equipment 200 in the case where the electronic equipment holder 100 is arranged at the center console 310 of the vehicle 300. FIG. 5A is a top view showing an electronic equipment holder according to the second embodiment. FIG. 5B is a perspective view showing an example of attaching the electronic equipment holder to vehicle, which shows vehicle interior to which the electronic equipment holder is attached to the center console.

For the electronic equipment holder 100 according to the second embodiment, the electronic equipment housing part 10 as the first housing part is arranged with having the predetermined angle φ such that the display 235 of the electronic equipment 200 is faced to the driver's seat side when the electronic equipment holder 100 is attached to the vehicle 300.

Although the electronic equipment housing part 110 according to the second embodiment mostly have the same structure with the electronic equipment housing part 10 according to the first embodiment, as shown in FIG. 5A, the electronic equipment housing part 110 is arranged to incline with the predetermined angle φ against the cup housing part 120 that is similar to the cup housing part 20 of the first embodiment. The predetermined angle φ can be set any angle not less than 0° and not more than 90°. An example of the predetermined angle φ is set to be 30° to easily view the display 235 of the electronic equipment 200 from the driver's seat 311 side.

As shown in FIG. 5B, when the electronic equipment holder 100 is attached to the center console 310 of the vehicle 300, the display 235 of the electronic equipment 200 is stand with facing against the driver's seat 311 side in the predetermined angle. Thus, the display 235 of the electronic equipment 200 is viewed from the driver's seat 311 side of the vehicle 300 more easier than from the passenger's seat 312 side of the vehicle 300 when viewing the display 235 of the electronic equipment 200.

### Effects of the Second Embodiment

The second embodiment have the following effects in addition to the effect according to the first embodiment.

(1) The display 235 of the electronic equipment 200 is viewed from the driver's seat 311 side of the vehicle 300 more easier than from the passenger's seat 312 side of the vehicle 300 when viewing the display 235 of the electronic equipment 200.

(2) The display 235 of the electronic equipment 200 is hardly viewed from the passenger's seat 312 side. Thus, driver's privacy can be protected from the passenger's seat 312 side when the driver stands the electronic equipment 200 in the electronic equipment housing part 110.

(3) As shown in FIGS. 5A and 5B, since the electronic equipment housing part 110 is arranged with inclining to the front direction (F-direction) of the vehicle 300, the lateral dimensional width W is smaller than that of the first embodiment, and the space in the lateral direction can be decreased.

### Third Embodiment

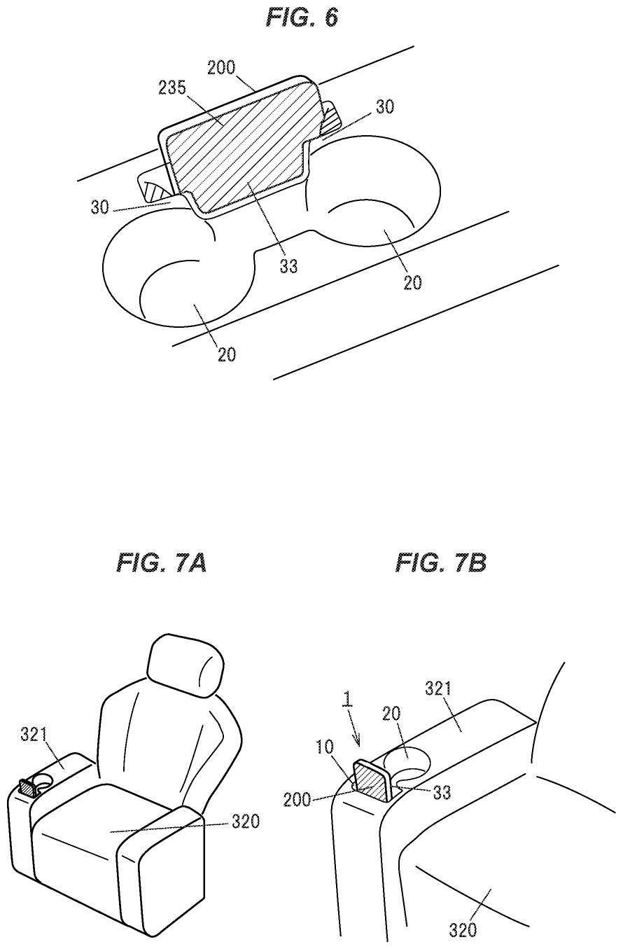

In the electronic equipment holder 1 according to the first embodiment, the cup housing part 20 as the second housing part can house a cup, and the electronic equipment housing part 10 as the first housing part and the cup housing part 20 are attached inside the vehicle interior of the vehicle 300 as the integral cup holder. In the third embodiment, the electronic equipment holder 1 has two cup housing parts 20 and the third embodiment comprises the communicating part 33 between the two cup housing parts 20. FIG. 6 is a perspective view showing an electronic equipment holder according to the third embodiment.

According to the third embodiment, the holder has the effects that, for example, the cups are respectively arranged from the driver's seat (D-seat) 311 side and the passenger's seat (P-seat) 312 side, and that the display 235 of the electronic equipment 200 can be easily viewed through the communication part 33. Specially, the display 235 of the electronic equipment 200 can be more easily viewed through the communicating part 33 if the cup is not arranged in the cup housing part 20.

### Fourth Embodiment

In the electronic equipment holder 1 according to the first embodiment, the cup housing part 20 as the second housing part can house a cup, and the electronic equipment housing part 10 as the first housing part and the cup housing part 20 are attached inside the vehicle interior of the vehicle 300 as the integral cup holder. In the fourth embodiment, the cup holder is arranged in an armrest part (armrest) 321 of the seat 320 of the vehicle 300. FIG. 7A is a perspective view showing a whole seat of vehicle in which an electronic equipment holder according to the fourth embodiment is applied. FIG. 7B is a perspective view showing a state that the electronic equipment holder is arranged at an armrest part (armrest) of the seat of vehicle.

According to the fourth embodiment, the exclusive electronic equipment holders 1 can be arranged at the respective seats 320. The electronic equipment holder 1 can be also used as the cup holder. In addition, the electronic equipment 200 can be arranged at the electronic equipment housing part 10. The fourth embodiment has the effect that the display 235 of the electronic equipment 200 can be easily viewed through the communicating part 33. Specially, the display 235 of the electronic equipment 200 can be more easily viewed through the communicating part 33 if the cup 80 is not arranged in the cup housing part 20.

### Fifth Embodiment

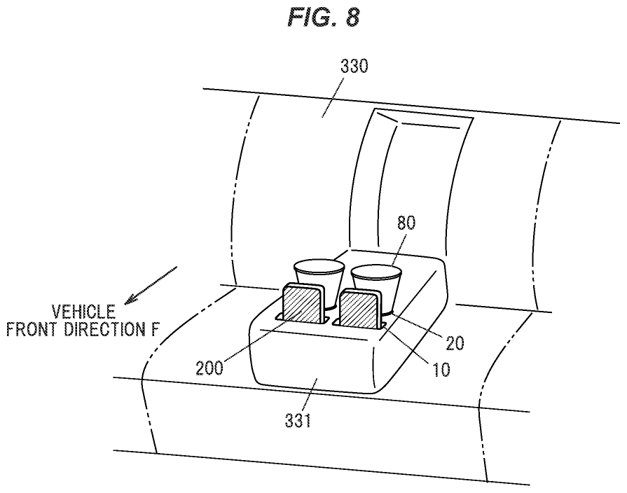

In the electronic equipment holder 1 according to the first embodiment, the cup housing part 20 as the second housing part can house a cup, and the electronic equipment housing part 10 as the first housing part and the cup housing part 20 are attached inside the vehicle interior of the vehicle 300 as the integral cup holder. In the fifth embodiment, a plurality of cup holders is arranged. FIG. 8 is a perspective view showing a state that the electronic equipment holder according to the fifth embodiment is arranged at an armrest part (armrest) in the center of rear seat of vehicle.

According to the fifth embodiment, for example, the cup holder is arranged at an armrest part (armrest) 331 at the center of rear sheet 330 of the vehicle 300. Passengers seated in the rear seat 330 can respectively use the cup holders. In addition, each of the electronic equipment 200 can be arranged in the electronic equipment housing part 10. The fifth embodiment has the effect that the display 235 of the electronic equipment 200 can be easily viewed through the communicating part 33. Specially, the fifth embodiment has the effect that the display 235 of the electronic equipment 200 can be more easily viewed through the communicating part if the cup 80 is not arranged in the cup housing part 20.

### Sixth Embodiment

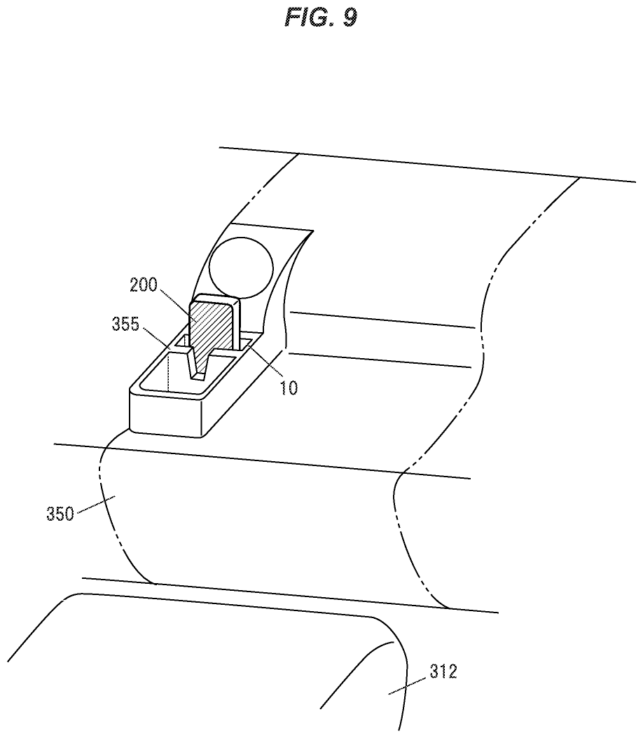

In the electronic equipment holder 1 according to the first embodiment, the cup housing part 20 as the second housing part can house a cup, and the electronic equipment housing part 10 as the first housing part and the cup housing part 20 are attached inside the vehicle interior of the vehicle 300 as the integral cup holder. In the sixth embodiment, the cup holder is arranged at an instrument panel. FIG. 9 is a perspective view showing a state that the electronic equipment holder according to the sixth embodiment is arranged at the instrument panel of a vehicle.

According to the sixth embodiment, for example, the cup holder is arranged at an upper surface part 355 of the instrument panel 350 in the vehicle front side of a front seat 312 of the vehicle. Passengers seated in the front seat 312 can respectively use the cup holders. In addition, each of electronic equipment 200 can be arranged in the electronic equipment housing part 10. The six embodiment has the effect that the display 235 of the electronic equipment 200 can be easily viewed through the communicating part. Specially, the sixth embodiment has the effect that the display 235 of the electronic equipment 200 can be more easily viewed through the communicating part if the cup 80 is not arranged in the cup housing part 20.

Although the embodiments of the invention have been described, the invention is not intended to be limited to the embodiments and the various kinds of modifications can be implemented without departing from the gist of the invention. In addition, the invention according to claims is not to be limited to the embodiments. Further, please note that all combinations of the features described in the embodiments are not necessary to solve the problem of the invention.

### REFERENCE SIGNS LIST

1 ELECTRONIC EQUIPMENT HOLDER
10 ELECTRONIC EQUIPMENT HOUSING PART
20 CUP HOUSING PART
30 WALL PART
33 COMMUNICATING PART
35 REAR WALL PART
36 OUTSIDE WALL PART
40 BODY
42 FLANGE PART
44 MAIN BODY PART
50 BATTERY CHARGER
52 FEEDING COIL
60 BOTTOM PART
61 GROOVE PART
62 BOTTOM PLATE
70 HOLDER
71 RIGHT HOLDING MEMBER
72, 76 ROTATIONAL FULCRUM
73, 77 ABUTMENT
74, 78 INCLINED ABUTMENT
75 LEFT HOLDING MEMBER
80 CUP
100 ELECTRONIC EQUIPMENT HOLDER
110 ELECTRONIC EQUIPMENT HOLDING PART
120 CUP HOUSING PART
200 ELECTRONIC EQUIPMENT
201, 202 SIDE SURFACE
235 DISPLAY
300 VEHICLE
310 CENTER CONSOLE
311 DRIVER'S SEAT (D-SEAT)
312 PASSENGER'S SEAT (P-SEAT)
320 SEAT
321, 331 ARMREST PART
330 REAR SEAT
350 INSTRUMENT PANEL
355 UPPER SURFACE PART
CL CENTER AXIS
W WIDTH
Z VERTICAL DIRECTION
θ INCLINED ANGLE
φ ANGLE

1. An electronic equipment holder, comprising:
a first housing part to hold an electronic equipment comprising a display; and
a second housing part that is adjacent to the first housing part and comprises a wall part comprising a partially notched communicating part to communicate with the first housing part,
wherein the display can be viewed from a side of the second housing part through the communicating part, and
wherein the first housing part are integrally formed with the second housing part.

2. The electronic equipment holder according to claim 1, wherein the electronic equipment holder is configured so as to be arranged at a center console of a vehicle such that the display can be more easily viewed from a driver's seat side of the vehicle than a passenger's seat side of the vehicle.

3. The electronic equipment holder according to claim 1, wherein the first housing part comprises a power feeder to feed power to the electronic equipment.

4. The electronic equipment holder according to claim 3, wherein the power feeder is configured to be contact-free.

5. The electronic equipment holder according to claim 1, wherein the first housing part comprises an inclined wall part to allow the electronic equipment to be leaned thereon.

6. The electronic equipment holder according to claim 1, wherein the first housing part comprises a positioning holder to hold the electronic equipment at a predetermined position.

7. The electronic equipment holder according to claim 1, wherein a bottom part of the first housing part and the second housing part comprises a groove part in which a wire can be arranged.

8. The electronic equipment holder according to claim 2, wherein the second housing part is configured to house a cup, and
wherein the first housing part and the second housing part are integrally formed as a cup holder provided in a vehicle interior of the vehicle.

9. The electronic equipment holder according to claim 8, wherein the electronic equipment holder comprises two of the second housing part and the communicating part between the two second housing parts.

10. The electronic equipment holder according to claim 8, wherein the cup holder is arranged at an armrest part of seat of the vehicle.

11. The electronic equipment holder according to claim 8, wherein the electronic equipment holder comprises plural ones of the cup holder.

12. The electronic equipment holder according to claim 8, wherein the cup holder is arranged above an instrument panel of the vehicle.
